(19) United States
(12) Patent Application Publication
(10) Pub. No.: US 2005/0013943 A1
(43) Pub. Date: Jan. 20, 2005

(54) Near uv excited phospors

(76) Inventor: Gareth Wakefield, Oxford (GB)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/487,314

(22) PCT Filed: Aug. 22, 2002
(86) PCT No.: PCT/GB02/03875

(30) Foreign Application Priority Data
Aug. 22, 2001 (GB) 0120460.1

(51) Int. Cl. B32B 5/16

(52) U.S. Cl. 428/1.21; 428/336; 428/328; 428/402

(57) ABSTRACT

Compounds which are excited in the near UV light are disclosed. These have the formula: X(YO₄)₃ wherein X represents a rare earth metal or more than one rare earth metal such that the total number of rare earth atoms represents a third of the number of YO₄ ions and Y represents tungsten, molybdenum, niobium or tantalum and are obtained by reacting ions of X with YO₄ ions in solution and recovering the resulting precipitate.

This invention relates to phosphors which are excited in the near UV. Such phosphors are generally excited by UV light in the wavelength range roughly 365-400 nm and emit at various visible wavelengths.

Such phosphors have two particular uses. Firstly, the phosphor can be used in LCD displays based on UV light passing through the LCD and exciting a phosphor screen. In this application the UV light must be as close to visible as possible to minimise any UV induced degradation of the liquid crystals. Secondly, the phosphor may be used in security marking. In this application the exciting light must also be as close to visible as possible to reduce any potentially harmful UV effects on the operator.

According to the present invention there is provided a process for preparing a compound of the formula:
X(YO₄)₃
wherein X represents a rare earth metal or more than one rare earth metal such that the total number of rare earth atoms represents a third of the number of YO₄ ions (i.e. such that the complex is stoichiometric), and Y represents tungsten, molybdenum, niobium or tantalum, which comprises reacting ions of X with YO₄ ions in solution and recovering the resulting precipitate Thus the compounds produced are tungstates, which are preferred, molybdates, niobates or tantalates.

X preferably represents a rare earth metal and, in particular, Tm (thulium), Dy (dysprosium), Sm (samarium), Er (erbium), Yb (ytterbium), Ce (cerium), Ho (holmium) and Pr (praseodymium), but, preferably, Eu (europium) or Th (terbium).

Although the compounds are generally salts of one rare earth metal, mixed salts can also obtained. Typically the mixed salts contain two rare earth atoms such that the compounds have the formula X¹ₓX²_{y}(YO₄)₃ where X¹ and X² represent different rare earth metals and x+y=1. Typically x=0.8 and y=0.2 as in Eu_{0.8}Tb_{0.2}(WO₄)₃. Such salts will generally give a multiple emission line spectrum.

It is particularly preferred that the compounds are in the form of small particles so that they can act more readily as phosphors. Preferably, the particles have a size not greater than 10 microns, preferably not greater than 3 or 4 microns and especially not greater than 2 microns. A particular advantage of the small particles is that they can be deposited by screen printing and other printing techniques including inkjet printing when they are used for security marking.

The compounds are prepared by reacting ions of X with YO₄ ions, typically in water, although acid or alkali can be used in appropriate circumstances, and recovering the resulting precipitate. By this solution process small particles can be obtained, in contrast to essentially solid phase processes.

The ions of X can be introduced as a water soluble or dispersible salt of X, preferably a halide and, in particular, a chloride. If necessary an acid or alkali is added to cause the ions to go into solution. Thus typically the YO₄ ions are added to a solution of the salt of X as a salt of YO₄. Generally, a precipitate is formed immediately.

In some instances it may be preferable to start with an oxide of X which may be obtainable more cheaply, with greater purity and convert in situ to the water soluble salt. Some oxides, though, should not be used because they are unstable and/or have a mixture of valency states. In this embodiment the oxide is typically dispersed in water. Acid, typically hydrochloric acid, is added to the dispersion to dissolve the oxide, generally at an elevated temperature, for example 50 to 90° C. The YO₄ salt can then be added to it.

The YO₄ salt is typically an alkali metal salt such as a sodium salt. Ammonium salts such as 5(NH₄)₂O. 12WO₃ 5H₂O can also be used.

Generally, the reactants should be used in approximately stoichiometric amounts i.e. about 1 mole of the salt of X is reacted with 3 moles of the YO₄ salt.

Desirably, after the precipitate has formed, it is washed and then dried. If desired, the material can then be ball milled or treated in any other way to reduce its particle size. At this stage the product is generally amorphous and only weakly luminescent.

The final product can be formed by a crystallisation step which involves firing it in air, typically at a temperature of from 500° or 600° to 1300° C., for example at 800° to 1000° C. and more particularly, about 850° C. Care should be taken, though, not to exceed the transition temperature above which luminescence may be quenched. This is between 900° and 1000° C. in the case of Eu(WO₄)₃. In general, firing takes place for 1 to 10 hours, typically 2 to 4 hours, for example about 3 hours.

While ball milling and the like will generally introduce defects such as internal defects, amorphous regions or internal strain fields it has been found that, following calcination the particles are generally crystalline, typically polycrystalline comprised of crystallites which are substantially free from such defects. Such particles having a size not exceeding 10 microns form another aspect of the present invention.

As indicated, the compounds of the present invention are particularly useful as phosphors in LCD displays. In this embodiment, the phosphor is typically dispersed in a binder material such as potassium silicate to form a composition which can be applied, typically to a glass screen, to form a layer in an LCD in a known manner.

The phosphors also find particular utility in security marking. For this purpose, the phosphors are dispersed in a suitable ink formulation. Typically such formulations involve a binder with the particles. Suitable binders include polymers and resins such as carboxylated acrylic resins and ethylene/vinyl ester copolymers e.g. ethylene/vinyl acetate copolymers e.g. containing about 40% vinyl acetate by weight.

Another application for the phosphors is based on their use in solid state lighting where the phosphors are excited by a near UV LED.

The following Examples further illustrate the present invention.

### EXAMPLE 1

Eu(WO₄)₃

0.3M EU203 (21.1 g/200 ml) is dispersed in DI water. HCl (37.7%) is added dropwise to the Eu₂O₃ mixture at 70° C. to dissolve the oxide. Upon dissolution the final pH of the solution is between 1 and 3.

To this solution is added 0.9M NaWO₄ (59.4 g/200 ml) dropwise. An immediate precipitation occurs. The precipitate is washed several times and dried. This precursor material is then ball milled to reduce particle size. The final product is formed by a crystallisation step, firing in air at 850° C. for 3 hours.

This reaction produces approximately 60 g of product.

### EXAMPLE 2

Tb(WO₄)₃

0.06M TbCl₃ (1.1 g/50 ml) is dispersed in DI water. To this solution is added 0.18M NaWO₄ (2.73 g/50 ml). An immediate precipitation occurs. This is then washed several times and fired in air at 850° C. for 3 hours.

The properties of the products obtained in these Examples are illustrated in the accompanying drawings in which:

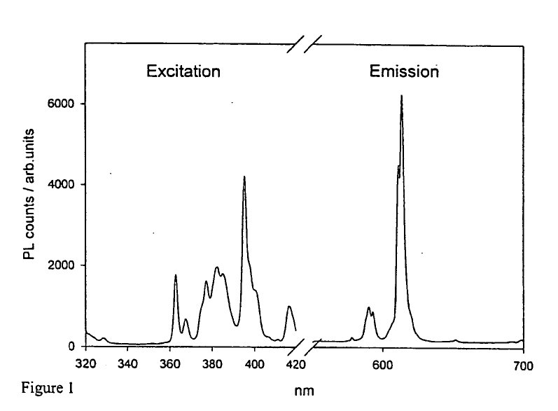

FIG. 1 shows the excitation and luminescence characteristics of Eu(WO₄)₃. There are two main excitation features, a broad band centred at 300 nm which is believed to be due to excitation to the WO⁻₄ ion, and a series of sharp lines believed to be due to excitation between the Eu³⁺ ion 4f-4f levels. Output is principally in the 619 nm electric dipole transition of europium.

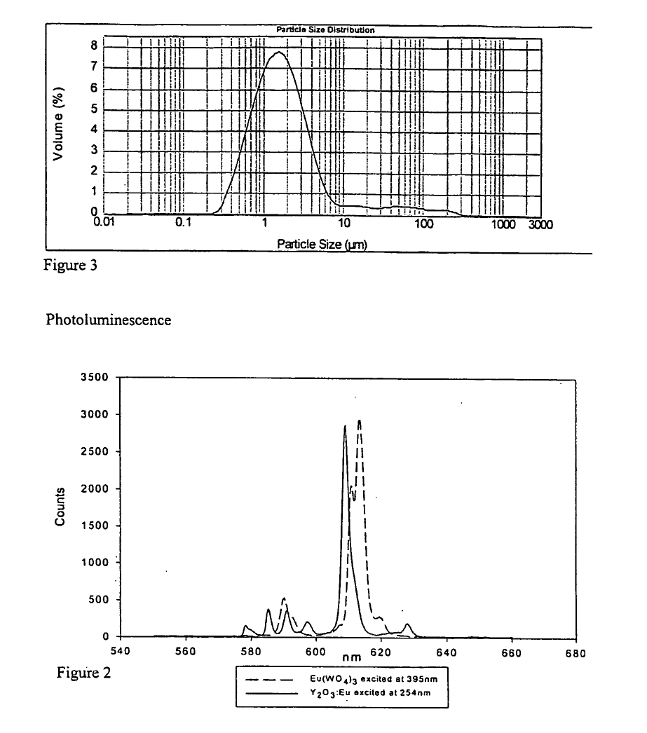

FIG. 2 shows a comparison of the luminescence efficiencies Eu(WO₄)₃ and a standard Y₂O₃:Eu phosphor. The results indicate that the phosphor efficiencies are approximately the same, indicating that the Eu(WO₄)₃ tungstate material is suitable as a near UV/red phosphor.

FIG. 3 is a particle size distribution graph for the Eu(WO₄)₃ obtained. The material has a mean particle size of 1.5 microns. This is suitable for printing techniques such as screen printing.

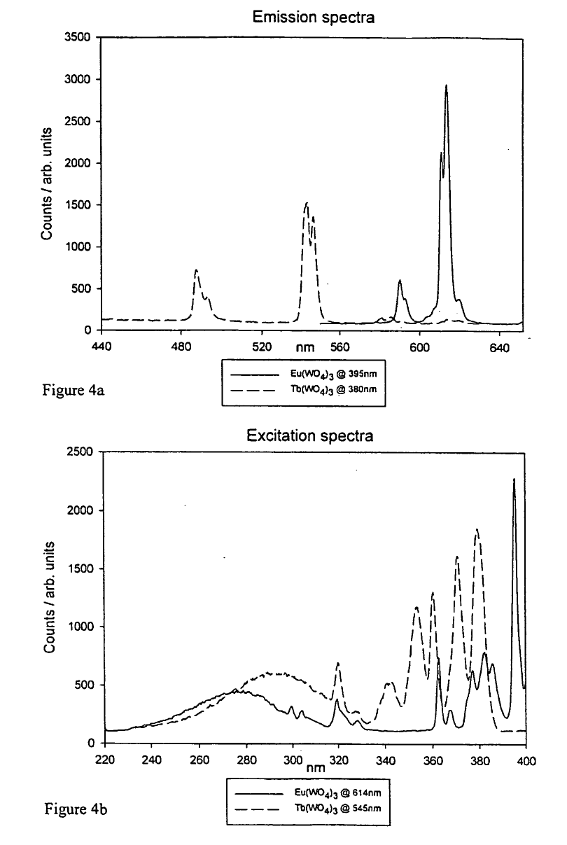

FIG. 4a gives a comparison of luminescence between red emitting Eu(WO₄)₃ and green emitting Tb(WO₄)₃ while in FIG. 4b the corresponding excitation spectra are shown. Although the peak emission heights are lower in the terbium phosphor compared to the europium phosphor the peaks themselves are broader. Integrating the peak intensities shows that the phosphor efficiencies are comparable. In the excitation spectrum of Tb(WO₄)₃ a series of 4f-4f absorption lines are shown. Therefore, Tb(WO₄)₃ is also useful as a near-UV to visible phosphor.

1. Process for preparing a compound of the formula:
X(YO₄)₃
wherein X represents a rare earth metal or more than one rare earth metal such that the total number of rare earth atoms represents a third of the number of YO₄ ions, and Y represents tungsten, molybdenum, niobium or tantalum which process comprises reacting ions of X with YO₄ ions in solution and recovering the resulting precipitate.

2. A process according to claim 1 wherein X represents one rare earth metal.

3. A process according to claim 1 wherein X represents Tm, Dy, Sm, Er, Yb, Ce, Ho or Pr.

4. A process according to claims 1 wherein X represents Eu or Tb.

5. A process according to claim 1 wherein Y is tungsten.

6. A process according to claim 1 for preparing europium tungstate or terbium tungstate.

7. A process according to claim 1 wherein the precipitate is subsequently fired at a temperature of at least 500° C.

8. A process according to claim 1 which is in the form of particles not exceeding 2 microns in size.

9. A process according to claim 1 wherein the ions of X are introduced by treating a dispersion of a corresponding oxide of X in water with a hydrohalic acid.

10. A process according to claim 1 wherein the YO₄ ions are introduced as a sodium salt.

11. A process according to claim I substantially as described in Example 1 or Example 2.

12. Particles of a compound of the formula:
X(YO₄)₃
wherein X and Y are as defined in claim 1 which have a size not exceeding 10 microns and which are composed of crystallites which are substantially free from internal defects, amorphous regions and internal strain fields.

13. Particles according to claim 12 which have a particle size not exceeding 2 microns.

14. Particles according to claim 12 which are of europium tungstate or terbium tungstate.

15. A liquid crystal display device which comprises particles obtained by a process as claimed in claim 1.

16. A device according to claim 15 wherein the particles are not exceeding 2 microns in size.

17. A composition suitable for use in the manufacture of a liquid crystal display device which comprises particles obtained by a process as claimed in claim 1 and a binder.

18. A security marking composition which comprises particles obtained by a process as claimed in claim 1 and a binder.

19. A composition according to claim 18 wherein the particles do not exceed 2 microns in size.
